(19) United States
(12) Patent Application Publication
(10) Pub. No.: US 2020/0362180 A1
(43) Pub. Date: Nov. 19, 2020

(54) THERMAL INSULATING AND FIRE PROTECTING MATERIALS AND PROCESS OF THEIR DEVELOPMENT

(71) Applicant: Premendra Pratap SINGH, Uttar Pradesh (IN)

(72) Inventor: Premendra Pratap SINGH, Uttar Pradesh (IN)

(21) Appl. No.: 16/612,667

(22) PCT Filed: May 11, 2018
(86) PCT No.: PCT/IB2018/053294

§ 371 Date: Nov. 11, 2019

(30) Foreign Application Priority Data
May 11, 2017 (IN) 201711016521

(51) Int. Cl. C09D 5/18; C09D 7/61; C09D 1/04; C03C 13/00; C03C 25/1095; C03C 25/44; C03C 25/465

(52) U.S. Cl. CPC C09D 5/18; C09D 7/61; C09D 1/04; C03C 2213/00; C03C 25/1095; C03C 25/44; C03C 25/465; C03C 13/00

(57) ABSTRACT

The present invention discloses compositions and materials for providing protection against heat and fire. More particularly, the present invention discloses thermal insulating and fire protecting materials and products and processes of developing the same. The materials of the present invention provide excellent insulation even above 500° C. without being degraded or change in shape.

### FIELD OF THE INVENTION

This invention relates to compositions and materials for providing thermal insulation and fire and/or flame retardation effects. More particularly, the invention relates to thermal insulating and fire protecting materials, products and processes thereof.

### BACKGROUND OF THE INVENTION

Thermal insulating and fire protecting materials have received remarkable attention due to its application in energy efficient buildings, domestic appliances, sleeping bags, wearing/protective apparel, upholstered furniture, mattress tops etc. The prior art discloses, traditionally organic heat insulating materials used such as polyurethane, polystyrene, phenol-formaldehyde resin etc. are hampered by their poor fire protection and non-biodegradation. To improve the fire resistance characteristic of organic insulating materials, phosphorous or halogenated compounds are used. These compounds are potentially vulnerable to environment and are toxic for human health. However, inorganic insulating materials are brittle or display high density and thermal conductivity with high carcinogenicity like glass wool and asbestos. The thermal insulating and flame resistance properties are significantly improved by organic/inorganic composites approach such as inorganic filler reinforced (carbon nanotube, montmorillonite, metal oxide, hydroxide etc.) organic matrix composites. For example phenol-formaldehyde/silica aerogel (organic/inorganic nanostructured composite) shows significantly lower thermal conductivity (24 mWm⁻¹K⁻¹) and excellent fire resistance (1300° C.) without mechanical disintegration, which is better than inorganic glass wool and organic expanded polystyrene foam. This is because of small structure size and high porosity, which reduces the mean free path and increases the scattering of phonons at the pore interface.

Among the various thermal insulating and fire protecting materials the most common is asbestos based materials. Currently there are many products available in the market for heat insulation and fire protection. Some of the materials are as follows:

1. Natural products: asbestos, glass fiber, mica, ceramic fiber blanket, etc.

2. Treated or developed product: like, kevalar, nomex, aluminized fiber, etc.

3. Some of the products developed and available for fire protection in the market are proximity suits for fire fighters, nomex fire fighter suits for normal fire hazards.

4. For insulation purpose the most widely used product in the industry is asbestos for temperature of more than 100° C. and nytril for temperature less than 100° C.

### PRIOR ART

In literature, several different mechanisms are used to develop thermal insulating or fire protecting materials.

WO 00/18993 provides a woven flame resistant fabric comprising dissimilar warp and fill yarns, the warp yarns comprise staple or filament fibers and have a Limiting Oxygen Index of at least 27, and the fill yarns comprise natural fibers and wherein the ratio of warp to fill yarn ends in the fabric is at least 1.0.

WO 2007/061423 discloses a flame resistant (FR) fiber blend that comprises amorphous silica fibers; and at least one fiber selected from the group consisting of FR fibers, binder fibers and mixtures thereof. A barrier fabric, manufactured from a blend of fibers comprises amorphous silica fibers; and at least one fiber selected from the group consisting of flame resistant (FR) fibers, binder fibers and mixtures thereof. A flame resistant fabric, manufactured from a blend of fibers comprises amorphous silica fibers; and at least one fiber selected from the group consisting of flame resistant (FR) fibers, binder fibers and mixtures thereof. A process for protecting materials in a product from fire and heat comprises assembling a flame resistant fabric adjacent to at least one component that comprises a material susceptible to damage due to exposure to fire and heat, occasioned by exposure to open flames.

U.S. Pat. No. 4,235,836A discloses a method of manufacturing thermally insulating, fire resistance material based on hollow particle of a glass or ceramic (pulverized fuel ash) together with sodium silicate as a binder through pressing followed by curing method. The material of invention follows deformation of substrate by virtue of its plasticity capable of deforming at high temperature (1100° C.) without fracture or loss of cohesion providing insulation and fire protection property.

Although several materials are available in market for thermal insulation or fire protection, but they are suffering from one or more limitations.

Insulation: Currently industry is using “ASBESTOS” material as insulating material, which is carcinogenic in nature, and is banned in European nations as well as in many other countries. So, there is a need of better materials for replacement of asbestos material.

Fire protecting shield/material: Currently fire safety materials in the form of apparel, made up of various composite materials, e.g. Proximity fire safety suits and Nomex Fire Suits are available, but they have limitations of providing fire protection for a very short duration of time, for example, nearby 5 minute duration from fire, as per the EN norms. Hence, there is a need for a better material/product which could withstand for higher time durations against fire, to safeguard the lives and property, from fire hazard across the globe.

### OBJECTS OF THE INVENTION

It is an object of the present invention to provide novel compositions and/or materials for providing thermal insulation, as well as protection against fire.

It is also an object of the present invention to provide thermal insulating and fire or flame protecting material, also hereinafter referred to as “TiFi” material.

Another object of this invention is to employ the novel thermal insulating and fire or flame protecting materials and developing thermal insulating and fire protecting materials and products.

Yet another object of the present invention is to employ the novel thermal insulating and fire and/or flame protecting material in combination with other protecting materials and develop multiple materials and products for insulation and fire protection.

Yet another object of the present invention is employ the novel thermal insulating and fire and/or flame protecting material of the present invention and develop various forms of materials like, yarn, fabric, sheets, gel, etc. for further utilization in production of various thermal insulation and fire protection products.

### SUMMARY OF THE INVENTION

The present invention is providing a thermal insulation and fire protecting (TiFi) composition or material. Said material comprises of:
(i) a fire retardant composition having
   (a) about 15 to 40 wt % of carbon.
   (b) about 0.5 to 35 wt % of silicate, and
   (c) about 0.25 to 45 wt % of silica.
   the percentage being based on weight of the fire retardant composition; and
(ii) a fiber; a reinforcing material; aluminium; a high temperature resistance solvent; graphite; or any combination thereof.

Said material is also intended to be used in developing and/or augmenting the thermal insulation properties as well as developing and/or augmenting properties related to fire and flame retardation or protection when used with other materials or products.

In one preferred embodiment, the silicate used in the thermal insulating and fire protecting material of the present invention is selected from abhrak/mica, sodium silicate, or a combination thereof.

In another preferred embodiment, the fiber in the thermal insulating and fire protecting material of the present invention is a glass fiber, silica fiber, or a combination thereof.

In yet another embodiment, the reinforcing material used in the thermal insulating and fire protecting material of the present invention comprises starch, benzoin oil, resin, magma, magma florex or a combination thereof.

In preferred embodiment, the high temperature resistance solvent used in the thermal insulating and fire protecting material of the present invention is selected from a silicate solution or an adhesive.

In a preferred aspect, the present invention provides a thermal insulating and fire protecting material, wherein the material is in the form of a gel (TiFi gel). Said TiFi gel is a thermal insulating gel, comprising about 20-40 wt % of carbon, about 15-35 wt % abhrak/mica, about 25-45 wt % aluminum, about 25-45 wt % silica, about 20-35 wt % graphite, and a high temperature resistance solvent, the percentage being based on weight of the insulating gel.

In a preferred embodiment, the present invention provides a process of preparing the thermal insulating gel (TiFi gel) of the present invention. The process comprises:
(i) Mixing about 20-40 wt % of carbon, about 15-35 wt % abhrak/mica, about 25-45 wt % aluminum, about 25-45 wt % silica, and about 20-35 wt % graphite to obtain a mixture; and
(ii) adding a high temperature solvent to the mixture to obtain the TiFi gel.

The TiFi gel of the present invention is also intended to be used in combination with other materials and/or products for providing enhanced thermal insulation.

In yet another aspect, the present invention provides a thermal insulating and fire protecting material in the form of yarn (TiFi Yarn). The TiFi yarn comprises glass fiber coated with a chemical liquid. The said chemical liquid of the present invention comprises:
(i) about 15-40 wt % carbon,
(ii) about 0.5-3 wt % silicate,
(iii) about 0.25-5 wt % silica,
(iv) about 0.25-4 wt % starch,
(v) about 6.5 wt % resin,
(vi) benzoin oil (in suitable amount to prepare liquefied resin),
(vii) about 0.1-3 wt % magma, and
(viii) magma florex in a ratio of 5 gm to 50 gm of magma florex to 200 liter of water; the percentage being based on weight of the glass fiber to be coated.

In a preferred embodiment, the present invention provides a process for preparing the thermal insulating and fire protecting yarn of the present invention. In one embodiment, the known processes for preparation of glass fiber yarn can be employed. In the present invention, the process of preparing the thermal insulating and fire protecting yarn (TiFi yarn) comprises:
(i) treating glass fiber with chemical liquid of the present invention to obtain a treated fiber;
(ii) passing the treated fiber in to a heat chamber having a constant temperature in the range 100-500° C., where it passes through a diamond polished dyes of size in the range of 0.5 mm to 1 mm, kept in series at equidistance with each other, wherein the same temperature is maintained for each diamond based dye throughout the heat chamber;
(iii) providing the treated fibers to a krill, wherein the krill is kept at the last end of the heat chamber; and
(iv) shaping the treated fibers into yarn and winding the yarn to make a cone of the yarn.

The chemical liquid used in the above process is prepared by mixing the fire retardant composition of the present invention with a reinforcing material as disclosed above.

In yet another aspect, the present invention provides thermal insulating and fire protecting fabric (TiFi fabric) comprising the thermal insulating and fire protecting yarn of the present invention. In a preferred embodiment, said thermal insulating and fire protecting fabric comprises additional fabric materials in combination with the thermal insulating and fire protecting yarn of the present invention.

In another aspect, the present invention provides an article comprising the thermal insulating and fire protecting material of the present invention. The said articles are selected from fire resistant and/or fire retardant hard board (TiFi Ceramic Hard board), fire resistant and/or fire retardant doors, fire proof lockers or cabins, fire resistant wearables, fire resistant and/or fire retardant wall panels or linings, fire resistant and/or fire retardant ceiling panels or linings, fire resistant and/or fire retardant furniture, thermal resisting composite materials, etc.

In a preferred aspect, the present invention provides the use of the thermal insulating and fire protecting material (TiFi material) of the present invention in certain pattern to develop various protective materials and thermal and fire resistant materials. In a preferred aspect, the present invention provides protective wearables, such as fire-protective suits, gloves, caps, helmets, aprons, etc. The said protective wearables comprise a pattern to achieve the desired properties of thermal insulation, fire protection, flame protection or flame retardation.

In a preferred aspect, the present invention provides a thermal insulating and fire protecting composite (TiFi composite heat insulator) material. In a preferred embodiment, the said composite material is a multilayer material. In a most preferred embodiment, the composite material comprises the multilayers in the following pattern:
(i) a layer of an aluminized glass fiber cloth on the uppermost side;
(ii) a layer of TiFi fabric of the present invention under the layer of the aluminized glass fiber cloth;
(iii) a layer of a glass fiber under the layer of TiFi fabric:
(iv) a layer of TiFi gel of the present invention spread on ceramic wool or ceramic fabric/cloth or both on its both side and covered with a cotton cloth or fire retardant cloth with the help of silicate glue or an adhesive under the layer of glass fiber followed by another TiFi fabric layer of the present invention; and
(v) a last layer of fire retardant cloth or blanket:
wherein all the layers are knitted from all four sides, as well as transactional sides with the TiFi yarn of the present invention.

In another aspect, the present invention provides a thermal insulating and fire protecting wearable material. In a preferred embodiment, the said thermal insulating and fire protecting wearable material is a multilayer material. In a most preferred embodiment, the said wearable material comprises the multilayers in the following pattern:
(i) a layer of an aluminized glass fiber on the outermost side followed by silica covering;
(ii) a layer of a non-woven carbon adjacent to the layer of the aluminized glass fiber with the silica covering;
(iii) a layer of TiFi fabric of the present invention, under the layer of the non-woven carbon;
(iv) a layer of a ceramic wool layering in between the TiFi fabric layer and the carbon non-woven layer;
(v) a layer of neoprene Teflon adjacent to ceramic wool layer; and
(vi) a last layer of woolen thermal lining or cotton cloth;
wherein all the layers are stitched with the TiFi yarn of the present invention.

In another embodiment, the said thermal insulating and fire protecting wearable material comprises the multilayers in the following patter:
(i) a layer of an aluminized glass fiber on the outermost side followed by silica covering;
(ii) a layer of TiFi fabric of the present invention adjacent to the layer of the aluminized glass fiber with the silica covering;
(iii) a layer of a non-woven carbon, under the layer of the TiFi fabric; (iv) a last layer of woolen thermal lining or cotton cloth;
wherein all the layers are stitched with the TiFi yarn of the present invention.

In another preferred embodiment, the thermal insulating and fire protecting wearable material of the present invention comprises the multilayers in the following pattern:
(i) a layer of a fire retardant cloth on the outermost side followed by silica covering:
(ii) a layer of non-woven carbon adjacent to the layer of the fire retardant cloth with the silica covering;
(iii) a layer of TiFi fabric of the present invention under the layer of the non-woven carbon;
(iv) a layer of neoprene rubber adjacent to the layer of point (iii), followed by a woolen thermal lining or cotton cloth:
wherein, all the layers are stitched with the TiFi yarn of the present invention.

In another embodiment, the said thermal insulating and fire protecting wearable material comprises the multilayers in the following pattern:
(i) a layer of a fire retardant cloth on the outermost side followed by silica covering;
(ii) a layer of TiFi fabric of the present invention adjacent to the layer of the aluminized glass fiber with the silica covering;
(iii) a layer of a non-woven carbon, under the layer of the TiFi fabric:
(iv) a last layer of woolen thermal lining or cotton cloth;

wherein all the layers are stitched with the TiFi yarn of the present invention.

In yet another aspect, the present invention provides thermal insulating and fire protecting door (TiFi Door). The said door provides protection against fire for an extended period of time. The said thermal insulating and fire protecting door comprises of
(i) zinc coated stainless steel sheet for steel frame, about 14-20 gauge, and/or wooden frames;
(ii) fire retardant glue:
(iii) calcium carbate:
(iv) TiFi fabric sheet of the present invention:
(v) rock wool or ceramic wool or a combination thereof; and
(vi) an intumescent material.

### DETAILED DESCRIPTION OF THE INVENTION

While the invention is susceptible to various modifications and alternative forms, specific embodiment thereof will be described in detail below. It should be understood, however that it is not intended to limit the invention to the particular forms disclosed, but on the contrary, the invention is to cover all modifications, equivalents, and alternative falling within the scope of the invention as defined by the appended claims.

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

The terms “comprises”, “comprising”, or any other variations thereof, are intended to cover a non-exclusive inclusion, such that one or more processes or composition's or methods proceeded by “comprises . . . a” does not, without more constraints, preclude the existence of other processes, sub-processes, composition, sub-compositions, minor or major compositions or other elements or other structures or additional processes or compositions or additional elements or additional features or additional characteristics or additional attributes.

The present invention provides novel materials and processes for the purpose of providing thermal insulation as well as fire and flame retardation and protection.

In a preferred embodiment, the present invention is providing a thermal insulating and fire protecting yarn (TiFi yarn), which is a combination of two or more different fibers, materials, chemicals etc. While many materials are known to have thermal insulation or fire retardation properties, but none of them show a high quality performance against thermal heat resistance and fire resistance, as compared to the TiFi yarn of the present invention.

In another embodiment, the present invention is providing a thermal insulation gel (TiFi gel) material comprising a combination of materials, which provides extra thermal insulating support to natural materials or even the materials of the present invention. Here also, while many materials are known to have thermal insulation properties, but none of them shows a high grade performance, as compared to the TiFi gel of the present invention.

The specific pattern or layering arrangement of various layers in the multilayer materials of the present invention also provide better thermal insulation and fire or flame protection as compared to the existing materials.

In a specific embodiment, the present invention is providing fire protective doors. Certain fire doors are already available in the market, but such doors have their specific dimensions and fire ratings (pre-defined) which may not be suitable for higher space volume and having higher volume of combusting materials. Hence, there is a need to provide fire protective doors providing enhanced fire protection based on the volume of space and based on the volume of combustible materials at the specific area, wherein such doors can properly and efficiently stop the spread of fire even for larger space or having higher amounts of combusting material. The thermal insulating and fire protecting doors (TiFi fire doors) of the present invention efficiently avoids the spread of fire even for higher volume area and having more combusting materials. Such thermal insulating and fire protecting doors of the present invention have higher capability to resist against the fire and heat than the existing fire doors and hence, the thermal insulating and fire protecting doors of the present invention help us in saving more lives and property from fire damage.

In yet another preferred embodiment, the present invention is providing hand gloves & body shields providing protection higher than 100° C. temperature or even beyond 800° C., up to 1000° C. or even higher than this. Mostly, Kevlar/leather and some similar hand gloves are used for this purpose, which do have potential of thermal resistance of around 50-250° C. or slightly higher than this, but not nearby or beyond 800° C. The present invention provides hand gloves made using the TiFi fabric of the present invention and other allied materials for providing protection even at higher temperature ranges. There is also a need for a body coverall or body shield to protect human body from the thermal radiation coming out of the furnace or environments where protection is required from high heat. The present invention also provides coverall or suits or shields made using the TiFi fabric of the present invention to protect the human body while working in an environment requiring protection from high heat, such as a furnace. The present invention provides the thermal insulating and fire protecting materials of the present invention used in specific pattern or layers in making this coverall for protecting at even high temperatures like 800° C. or higher.

The present invention describes thermal insulating and fire protecting materials and process of their development. The present invention also provides development of various composite products, with the help of the thermal insulating and fire protecting materials of the present invention, which involves the combination of various fibers, fabrics, and natural materials, derived material or treated natural materials with other natural material or chemical, etc. For thermal heat resistance, the present invention provides certain natural materials and developed materials (derived) in specific patterns which were not disclosed earlier, to develop insulation systems, showing better thermal insulation and fire protection as compared to the existing materials or products.

The thermal insulating and fire protecting materials of the present invention are capable of providing resistance against the flame of fire for around 30 minutes or more. This provides sufficient time for taking additional safety measures in case of fire and/or heat exposure accidents.

Thermal Insulating and Fire Protecting Yarn (TiFi Yarn)

In one of the preferred embodiments, the present invention provides a manufacturing process of the TiFi yarn of the present invention, The TiFi yarn of the present invention shows a high quality performance against thermal heat resistance and fire resistance, while the components with which the TiFi yarn of the present invention is made, if tested individually, do not show similar thermal heat resistance and fire resistance. The TiFi yarn of the present invention has the potential to withstand with the temperature ranges from 300° C. to 800° C. for a period of 5 minutes to 5 hrs, depending upon the corresponding temperature. Such potential of providing resistance for higher periods of time, up to a few hours, provides sufficient time to take additional safety measures in case of fire and/or heat exposure accidents.

Process of developing the TiFi yarn of the present invention:

1. Glass fibers are put on relays and passed from a chemical liquid, prepared to treat these glass fibers. The chemical liquid can be filled into a separate tank, just next to the box of relays.

2. The chemical liquid used for deep coating on glass fibers, comprises of the following:
a. Carbon (15 wt. %-40 wt. % of the total glass fiber to be coated)
b. Silicate (0.5 wt. %-3 wt. %)
c. Silica (0.25 wt. %-5 wt. %)
d. Starch (0.25 wt. %-4 wt. %)
e. Benzoin oil (as per the need to prepare liquefied resin)
f. Resin (6.5 wt. %)
g. Magma (0.1 wt. %-3 wt. %)
h. Magma florex (in the ratio of 5 gm to 50 gm of magma florex to 200 liter of water).

3. Mixing up the above said chemical composition in prescribed ratio and making the required chemical liquid to be coated on the glass fibers.

4. With the help of the relay on level 1, the glass fiber is passed through the prepared chemical liquid.

5. After getting treated with this chemical, these fibers come into the heat chamber (having constant temperature of about 100-500° C., preferably about 450° C.), where it passes through diamond polished dyes of desired size (0.5 mm-1 mm), kept in series at equidistance with each other.

6. Coming through various such dyes, the treated fibers, finally reaches to the krill.

7. Krill is kept at the last end of the heat chamber and temperature remains same for each diamond based dyes throughout the heat chamber.

8. Fibers get shaped into yarn and sent to the winding head to make the final cone of the TiFi yarn of the present invention.

In another embodiment, the present invention also provides preparation of TiFi fabric, TiFi fabric sheets and cloth, which are prepared by the TiFi yarn of the present invention.

Thermal Insulating and Fire Protecting Gel (TiFi Gel)

In yet another embodiment, the present invention provides manufacturing of TiFi gel. Such TiFi gel is useful in providing thermal insulation and fire or flame protection to materials, where any fabric, TiFi ceramic hard board, ceramic board or similar substances, cannot be used.

For example, a coating of the TiFi gel on a surface can provide the desired thermal insulation and fire protection. Also, the TiFi gel of the present invention can be used with the thermal insulating and fire protecting materials of the present invention, or other known materials to further enhance the thermal insulation and fire protection properties.

If the TiFi gel of the present invention is applied on any of the fire resistance materials, the gel enhances its power to resist more heat and fire to pass from one surface to the other surface.

Composition of the thermal insulating and fire protecting gel (TiFi gel) of the present invention:
about 20-40 wt. % of carbon:
about 15-35 wt. % of abhrak (mica);
about 25-45 wt. % of aluminium;
about 20-35 wt. % of graphite;
about 25-45 wt. % of silica; and
high temperature resistance solvent.

Process for preparing the TiFi gel of the present invention:

1. Providing desired amounts of carbon, abhrak, aluminium, silica and graphite, and mixing to obtain a mixture.

2. Adding required amount of a high temperature solvent to the mixture to obtain a TiFi gel.

Thermal Insulating and Fire Protective Doors: TiFi Fire Doors

In one of the preferred embodiments, the present invention provides TiFi Fire Doors and manufacturing process of the same. Presently available fire doors are being developed with the help of calcium carbate along with rock wool for steel frame/wooden frame fire door or wooden fire doors. Such known fire doors are rated for 1 hr, 2 hr & 4 hr, respectively, for specified volume of covered area. The intensity of fire is dependent on the volume of combusting material, volume of covered area, supply of oxygen and air flow rate. Hence, if all these factors are on the higher side, then the quantum of fire could be unlimited. Therefore, most of the times, such known fire doors would not withstand for higher periods of time against fire accidents, thereby causing reduction of the time duration for spread of the fire.

Therefore, there is a need of a product which could be capable of withstanding higher range of temperatures for a bit higher duration of time, to prevent spread of fire and heat for higher durations. The TiFi Fire Doors of the present invention provide such protection and sustain for the longer duration than the existing fire doors even at higher temperatures.

In preferred embodiments, the TiFi Fire Doors of the present invention are as follows:

1. Infusion of thermal insulating and fire protecting Hard Board (TiFi Ceramic Hard Board).

2. Thermal insulating and fire protecting Fire Door: Developing strong and powerful TiFi Fire Door with the use of TiFi fabric of the present invention.

Methodology:

Preparation of TiFi Hard Board of the present invention:

1. Making a liquid paste of resin:

2. Mixing this paste with ceramic fiber (about 50-90 wt. %) to obtain a composition;

3. Putting the composition in a dye of desired size under pressure of about 4 tons to 20 tons for a period of about 5 hrs to 20 hrs:

4. Providing heat keeping constant temperature of around 100° C. to 700° C., while keeping the developed material on pressure machine:

5. Optionally applying TiFi fabric sheet or TiFi insulating gel of the present invention.

In a preferred embodiment, the present invention provides a TiFi Fire Door as following:

A: Thermal Insulating and Fire Protecting Complete Fire Door (TiFi CFD) Following materials are used in preparing the complete fire door (TiFi CFD):
TiFi Ceramic Hard Board of the present invention;
Ceramic wool or rock wool;
Calcium carbate;
Zinc coated Stainless Steel Sheet or wooden frame sheets;
Intumescent material; and
Fire Retardant Glue.

Process for preparing the Tifi Complete Fire Door (Tifi CFD):

1. Applying Fire Retardant Glue on both sides of the TiFi Ceramic Hard Board of the present invention and applying ceramic wool or rock wool (about 2 mm-20 mm) on both sides of the hard board; Tifi gel or Tifi fabric can also be used in between hard board and ceramic wool or rock wool;

2. Applying calcium carbate sheet (about 4 mm-14 mm thick) on both sides of the above;

3. Applying intumescent material on all sides of the above to obtain door material;

4. Fixing the zinc coated Stainless Steel sheets or wooden frame sheets on the above door material from all sides with the help of Fire Retardant Glue:

B: Thermal Insulating and Fire Protecting Doors (Tifi Fire Door)

Following materials are used in preparing the TiFi Fire Door (TiFi FD):
Stainless Steel Sheet for Steel frame, about 14-20 gauge, zinc coated or wooden frame for wooden fire door;
Fire Retardant Glue:
Calcium carbate;
TiFi fabric sheet of the present invention;
Rock Wool/Ceramic Wool; and
Intumescent material.

Process for Preparing the Tifi Fire Door (TiFi FD):

1. Providing about 20 mm-40 mm thick ceramic wool or rock wool or combination of both:

2. Covering the above with the TiFi Fabric Sheet of the present invention (1-3 layers on each side) from both sides and fixing it with Fire Retardant Glue:

3. Covering the above with about 2 mm to 20 mm thick ceramic wool from both sides with Fire Retardant Glue:

4. Applying calcium carbate sheet of about 4 mm to 14 mm thickness on the both sides.

5. Applying intumescent material between the calcium carbate and outermost layer to stop the entry of air into the sheet developed; and

6. Applying Fire Retardant Glue on its outer surface and fixing it with about 14-20 gauge zinc coated SS sheet on both sides.

Manufacturing of Thermal Insulating and Fire Protecting Composite Materials (TiFi Composite Insulation)

In one of the preferred embodiments, the present invention provides manufacturing of a fire and thermal resisting composite (TiFi composite) materials. There are lots of thermal insulation solutions available in the market for example Aluminium, glass fiber, asbestos, Teflon, or various other materials developed by the use of such materials. But usually, it is found that, none of these materials withstand the fire/heat for more than 30-60 minutes duration or for higher duration than this at constant temperature of 200° C. to 500° C. or more. However, the TiFi materials and products of the present invention, with their specific combination and pattern can adequately withstand the exposure to such high temperatures for higher duration of time.

It has been found that, if a composite pad developed by using the TiFi materials of the present invention, is put on a heated material of such temperature (200° C. to 500° C.) for around 30 minutes time or more than this, then there is negligible temperature increase on its non-exposed surface. Hence, products developed with the TiFi materials of the present invention provide safety against exposure to high temperature to employees working in an environment in which they are liable for exposure to heat at very high temperature. The TiFi materials developed according to the present invention can withstand heat for 1 hrs to 10 hrs duration or even more than that, depending upon the range of the temperature. For example, lesser the temperature, higher would be time duration for the thermal resistance or vice a versa. The present invention also provides that, for obtaining TiFi materials or TiFi composites for providing protection for higher duration, even for higher temperature range (e.g. 500° C. to 1000° C.), suitable products can be developed by repeating the pattern according to the present invention. There would be very negligible heat transfer to the non-exposed side of the composite sheets according to the present invention, which is tolerable to the human skin.

A thermal insulator sheet for temperature range of 100° C. to 500° C. temperature for time duration range of 30 minutes to 10 hrs or more can be developed in following manner:

Preparation of fire and thermal resisting Composite Materials (TiFi composites), containing the following or combination of any of the following:
Aluminium glass fiber sheet;
Glass fiber cloth;
Cotton cloth;
TiFi Gel of the present invention;
Ceramic wool or ceramic cloth or both treated with chemical;
Silicate glue;
TiFi fabric of the present invention:
Fire Retardant Cloth; and
TiFi Yarn of the present invention.

Process for preparing the Fire and Thermal Resisting Composite Materials (TiFi composite sheets):

1. Providing the aluminized glass fiber cloth on the uppermost side;

2. Applying the TiFi fabric under it;

3. Applying Glass fiber under it;

4. Spreading the TiFi gel on ceramic wool or ceramic cloth or both on its both sides and covering it with cotton cloth or other fire retardant cloth with the help of silicate glue;

5. Applying this layer of step 4. under the glass fiber layer followed by another TiFi fabric layer;

6. Applying a fire retardant cloth or blanket as the last layer; and

7. Knitting the entire sheet so developed in step 6. from all four sides, as well as transactional sides with the help of TiFi yarn of the present invention.

Fire Suits

Proximity suits/Nomex suits are available in the market but can withstand only for 2 minute to 5 minutes hardly while kept near flash fire. Moreover lots of suffocation is created inside the suits, which make the user uncomfortable to properly fight with the fire. The product developed according to the present invention is able to withstand for more than 5 minutes duration nearby such flash fire and is comfortable to the user as well. The fire fighter would be able to safeguard more lives stuck into the fire and could also minimize the financial damage with the help of such high quality protective apparels. The protective apparels (TiFi apparels) of the present invention are better in terms of sustainability for time longevity at temperature in the range of 400° C. to 800° C.

a. Proximity Suits:

In one of the embodiments, the present invention provides a proximity suit. The entire suit will contain coat, trouser, hand gloves, boot and hood.

Following materials are used in preparing the proximity suits according to the present invention:
1. Aluminized glass fiber:
2. Silica sheet;
3. Ceramic wool/fabric:
4. TiFi fabric of the present invention:
5. Neoprene teflone sheet;
6. Non-woven carbon and
7. Fire Retardant Cloth.

Process for preparing the proximity suit is as follows:

Coat, Trouser and Hand Gloves:
(1) The outermost layer is aluminized glass fiber (2), followed by silica covering (3) There is a ceramic wool or ceramic cloth or both, (4) which is followed by TiFi fabric covered at its both side (front & back side) by carbon non-woven. Just under it neoprene Teflon layer (5) is provided followed by woolen thermal lining or cotton cloth (6). The entire suit is stitched with the help of Fire Retardant yarn and supported by TiFi yarn of the present invention, so that the structure could withstand during immense heat or fire.

There is space at the back side of the coat to carry the breathing apparatus. There is a zip in the coat to close or open the trouser, while there can be elastic on the waist as well as strips to hold the trouser. Coat will be covering the entire two hands up to the wrist and covering the body from neck to thighs. Trouser would be covering entire two legs.

Hood: An ISI marked/EN approved strong helmet is covered with all above said layers as used for making coat & trouser. Its length can cover the neck too. There is F.R Glass placed in center of the hood to keep the vision clear.

Hand gloves: Five finger hand gloves covering up to wrist (14 inch), made up of all above said layers as used in developing trousers and coat.

Boot: Fire rated sole is the lowest layer, while just above it there is TiFi fabric layer of the present invention to protect the upcoming heat into the feet from surface, it is supported by covering of FR material (cotton fabric). The upper covering is of all the above said materials as used in developing coat & trouser to maintain the quality same throughout the fire suit developed. There is a provision of zip, near by the ankle to facilitate the shoe to wear it or put it out.

b. Thermal Insulating and Fire Protecting Fire Suits (TiFi Fire Suits)

In yet another embodiment, the present invention provides a thermal insulating and fire protecting fire suit (TiFi Fire Suit). The entire suit contains coat, trouser, hand gloves, boot and hood.

Following materials are used in preparing the thermal insulating and fire protecting fire suit:
Fire Retardant Cloth:
Non-woven carbon layer:
TiFi fabric of the present invention;
Neoprene rubber;
Cotton lining;
TiFi yarn of the present invention and Fire Retardant Yarn;
ISI marked/EN certified helmet;
Fire Retardant sole; and
Silicate glue.

Process for preparing the thermal insulating and fire protecting Tifi fire suit is as follows:

Coat, Trouser and Hand Gloves:

The outermost layer is Fire Retardant cloth (1), followed by silica covering (2), which is followed by TiFi fabric layering under it (3), immediate to it there is non-woven carbon layer (4). Just under it neoprene rubber layer (5) is applied, followed by woolen thermal lining or cotton cloth (6). The entire suit is stitched with the help of FR yarn and supported by TiFi yarn, so that the structure could withstand during immense heat or fire. There is space at the back side of the coat to carry the breathing apparatus. There is a zip in the coat to close or open the trouser, while there can be elastic on the waist as well as strips to hold the trouser. Coat will be covering the entire two hands up to the wrist and covering the body from neck to thighs. Trouser would be covering entire two legs.

Hood: An ISI marked/EN approved strong helmet is covered with all above said layers as used for making coat & trouser. Its length would be covering the neck too. There is F.R Glass placed in center of the hood to keep the vision clear.

Hand gloves: Five finger hand gloves covering up to wrist (14 inch), made up of all above said layers as used in developing trousers and coat.

Boot: Fire rated sole is the lowest layer, while just above it there is TiFi fabric layer to protect the upcoming of heat into the feet from surface, it is supported by covering of FR material (cotton fabric). The upper covering is of all the above said materials as used in developing coat & trouser to maintain the quality same throughout the fire suit developed. There is a provision of zip, near by the ankle to facilitate the shoe to wear it or put it out.

Hand gloves & body shield; There are lots of varieties of safety hand gloves available in the market for various temp range.

But there are no safety hand gloves for providing protection in temperature range of 300° C. to 1000° C. or even more than this. As compared to this, the products developed according to the present invention have following characteristics:

a. Hand gloves (14 inch) to hold material of temp up to 1000° C. (Palm Protection)

b. Hand gloves (14 inch) where we need to protect entire hand in a temp range of 1000° C.

a. Hand Gloves to Hold Material of Temperature Up to 1000° C.

In one of the embodiments, the present invention provides hand gloves to hold a solid metal or iron rod of a temperature of up to 1000° C.

Materials used:
Ceramic fabric/ceramic wool or both:
FR cloth;
TiFi cloth;
Woolen lining.

Process of Development:

Five finger hand gloves, 14 inch long, is made by keeping the ceramic fiber as outer most layer on palm side followed by ceramic wool, covering all five fingers along with the entire palm. It is followed by by TiFi fabric and then FR cloth. The inner most layer is of woolen lining. The entire glove is stitched with FR yarn and supported by TiFi yarn.

b. Hand Gloves where there is Need to Protect Entire Hand from Temperature of 1000° C.

In one of the embodiments, the present invention provides hand gloves where there is need to protect entire hand from temperature of up to 1000° C.

Materials used:
Ceramic fabric;
TiFi fabric;
Ceramic wool;
FR cloth/woolen lining;
FR yam; and
TiFi yarn.

Process of Development:

Five finger hand gloves, 14 inch long, is made by keeping the ceramic fiber as outer most layer on both side of hand (palm & back of the palm). It is followed by double layer of TiFi fabric. Ceramic wool (0.5 mm-5 mm thick) is applied in between the two layers of the TiFi fabric used. The inner most layer is of woolen lining or cotton/FR rated cloth. The entire glove is stitched with FR yarn and supported by TiFi yarn.

### EXAMPLES

Having described the basic aspects of the present invention, the following non-limiting example illustrate specific embodiment thereof.

### Example-1

Testing of the Material:

Test No. 1:

Thermal heat protector. i.e. TiFi composite material developed according to the present invention. The TiFi fiber/TiFi yarn developed according to the present invention, which is one of the layers of this TiFi composite product, is put into a furnace at 300° C. temperature (constant) for 30 minutes duration. Very negligible degradation was found in the condition of the material, which is around 4% only. Secondly, when the heated TiFi yarn is brought out from the furnace from 500° C. after one and a half hour time, it gave a feel just like a normal body temperature or in another words, it did not give sense of heat or burning, nor did it stick as a sticky item on the skin.

Based on this test, it can be concluded that this material is very much safe to use by human beings for 30 minute duration at constant temperature of 300° C. as it shows very negligible degradation in its natural condition in terms of weight, color and strength.

Test No. 2:

Putting the same material at 500° C. temperature in a furnace for two different durations: first for 30 minutes duration, and found the degradation of around 10% in its weight, while found its tensile strength up to the mark.

Second Time:

The same material is put for 1 hr at 500° C. temperature, and found 40% loss in its weight. Or in other words, around net 50% loss after 1 hr 30 minutes duration time on exposure at 500° C. constant temperature.

Based on these tests, it can be concluded that the material developed according to the present invention can safely provide protection from thermal heat of 500° C. for around up to 3 hrs duration, which is significant time duration, during which, additional safety measures can be arranged.

### Example 2

The thermal insulating and fire protecting material (TiFi fabric/TiFi yarn) was kept on LPG GAS burner for around more than 2 hr time, and the results were as follows:

1. No burning of the material was found.

2. Reduction in weight observed was very negligible.

3. The touch feel of the materials used was cool while the material was brought out from the flame of the burner.

4. No sticky nature was observed in the ingredients of this product.

5. Some of the products were found to be hot because of the flame, but it was only for around 60-70° C. meaning it is tolerable to naked skin, and also, it gets cooled down to the normal room temperature within couple of seconds only.

### REFERENCES

[1] Z. Yu, N. Yang, V. Apostolopoulou-kalkavoura, B. Qin, Z. Ma, W. Xing, et al., Fire-Retardant and Thermally Insulating Phenolic-Silica Aerogels, (2018) 1-6. doi:10.1002/anie.201711717.
[2] F. Chen, J. Zhang, N. Li, C. Zhang, B. Ji, L. Hu, et al., Heat insulating, fire retardant and flexible inorganic nanocomposite paper, 144 (2018) 281-289. doi:10.1016/j.matdes.2018.02.039.
[3] T. Insultaion, R. U.S.A. Data, United States Patent (19), (1996).

| | | UTILITIES OF HEAT INSULATING & FIRE PROTECTIOIN MATERAIL | | | | | | | | | |
|---|---|---|---|---|---|---|---|---|---|---|---|
| INDUSTRIES & | | VARIOUS FOCUS AREA OF USE | | | | | | | | | |
| UTILITY AREAS | | CUSTOMER CENTRIC AREA OF USE/or other | | | | | COMPANY CENTRIC FOUS AREA-MFG. | | | | |
| Sr. | | focus area of use | | | | | ETC | | | | |
| No. | | utility area where this product can be used | | | | | utility area where this product can be used | | | | |
| 1 | AUTO MOBILES INDS. | | | | | | | | | | |
| | Sr. No. | 1 | 2 | 3 | 4 | 5 | 6 | 7 | 8 | 9 | 10 |
| | Name the | Engine | Bonut | Seat | Fuel | Roof | Welding | Furnace | Fire | Paint | Others |
| | utility area | Area | | Cover | Tank | | Area | | Door | Booth | |
| | Fire resistance | insulation | Cover All | Cover All | . . . | . . . | suit/ | suit/ | Door | suit | . . . |
| | | | | | | | Gloves | Gloves | | | |
| | Heat resistance | Cover All | Cover All | Cover All | . . . . | insulation | apperin/ | suit/ | Door | suit | . . . |
| | | | | | | | Gloves | Gloves | | | |
| 2 | OIL & GAS INDS. | | | | | | | | | | |
| | Sr. No. | 1 | 2 | 3 | 4 | 5 | 6 | 7 | 8 | 9 | 10 |
| | Name the | Fire | | | | | Welding | Furnace | Fite | Paint | Others |
| | utility area | Fighter | | | | | Area | | Door | Booth | |
| | | Team | | | | | | | | | |
| | Fire resistance | Fire Suit | | | | | suit/ | suit/ | Door | suit | . . . |
| | | | | | | | Gloves | Gloves | | | |
| | Heat resistance | Proximity | | | | | apperin | suit/ | Door | suit | . . . |
| | | Suit | | | | | | Gloves | | | |
| 3 | IRON & STEEL INDS. | | | | | | | | | | |
| | Sr. No. | 1 | 2 | 3 | 4 | 5 | 6 | 7 | 8 | 9 | 10 |
| | Name the | Sheet | | Fire | | | Welding | Furnace | Fire | Paint | Others |
| | utility area | Cooling | | Fighter | | | Area | | Door | Booth | |
| | | | | Team | | | | | | | |
| | Fire resistance | | | Fire Suit | | | suit/ | suit/ | Door | suit | . . . |
| | | | | | | | Gloves | Gloves | | | |
| | Heat resistance | Insulator | | Proximity | | | apperin/ | suit/ | Door | suit | . . . |
| | | Layer | | Suit | | | Gloves | Gloves | | | |
| 4 | RAILWAYS | | | | | | | | | | |
| | Sr. No. | 1 | 2 | 3 | 4 | 5 | 6 | 7 | 8 | 9 | 10 |
| | Name the | Coach | | Fire | | | Welding | Furnace | Fire | Paint | Others |
| | utility area | Protection | | Fighter | | | Area | | Door | Booth | |
| | | | | Team | | | | | | | |
| | Fire resistance | Insulation | | Fire Suit | | | suit | suit | Door | suit | . . . |
| | Heat resistance | | | Proximity | | | apperin | suit | Door | suit | . . . |
| | | | | Suit | | | | | | | |
| 5 | AVIATION INDS. | | | | | | | | | | |
| | Sr. No. | 1 | 2 | 3 | 4 | 5 | 6 | 7 | 8 | 9 | 10 |
| | Name the | | | Fire | | Staff | Welding | | Fire | | Others |
| | utility area | | | Fighter | | Resque | Area | | Door | | |
| | | | | Team | | | | | | | |
| | Fire resistance | | | Fire Suit | | Suit | suit | | Door | | . . . |
| | Heat resistance | | | Proximity | | Suit | apperin | | Door | | . . . |
| | | | | Suit | | | | | | | |
| 6 | GARMENT MFG./FOAM MATTERESSES MFG. | | | | | | | | | | |
| | Sr. No. | 1 | 2 | 3 | 4 | 5 | 6 | 7 | 8 | 9 | 10 |
| | Name the | Fire | | Staff | | | Welding | | Fire | | Others |
| | utility area | Fighter | | Resque | | | Area | | Door | | |
| | | Team | | | | | | | | | |
| | Fire resistance | Fire Suit | | Suit | Net, | | suit | | Door | | . . . |
| | | | | | Ropes | | | | | | |
| | | | | | & | | | | | | |
| | | | | | Ladder | | | | | | |
| | Heat resistance | Proximity | | Suit | | | apperin | | Door | | . . . |
| | | Suit | | | | | | | | | |
| 7 | HOSPITALS | | | | | | | | | | |
| | Sr. No. | 1 | 2 | 3 | 4 | 5 | 6 | 7 | 8 | 9 | 10 |
| | Name the | Fire | | Students. | | | Chemical | | Fire | | Others |
| | utility area | Fighter | | & Staff | | | Protection | | Door | | |
| | | Team | | Resque | | | | | | | |
| | Fire resistance | Fire Suit | | Suit | Net, | | | | Door | | . . . |
| | | | | | Ropes | | | | | | |
| | | | | | & | | | | | | |
| | | | | | Ladder | | | | | | |
| | Heat resistance | Proximity | | Suit | | | Suit to | | Door | | . . . |
| | | Suit | | | | | Protect | | | | |
| | | | | | | | from Heat | | | | |
| | | | | | | | of Chem | | | | |
| 8 | EDUCATION INDS. | | | | | | | | | | |
| | Sr. No. | 1 | 2 | 3 | 4 | 5 | 6 | 7 | 8 | 9 | 10 |
| | Name the | Fire | | Students. | | | Welding | Furnace | Fire | Paint | Others |
| | utility area | Fighter | | & Staff | | | Area | | Door | Booth | |
| | | Team | | Resque | | | | | | | |
| | Fire resistance | Fire Suit | | Suit | Net, | | suit | suit | Door | suit | . . . |
| | | | | | Ropes | | | | | | |
| | | | | | & | | | | | | |
| | | | | | Ladder | | | | | | |
| | Heat resistance | Proximity | | Suit | | | apperin | suit | Door | suit | . . . |
| | | Suit | | | | | | | | | |
| 9 | MANUFACTURING UNITS | | | | | | | | | | |
| | Sr. No. | 1 | 2 | 3 | 4 | 5 | 6 | 7 | 8 | 9 | 10 |
| | Name the | Fire | | | | | Welding | Furnace | Fire | Paint | Others |
| | utility area | Fighter | | | | | Area | | Door | Booth | |
| | | Team | | | | | | | | | |
| | Fire resistance | Fire Suit | | | | | suit/ | suit/ | Door | suit | . . . |
| | | | | | | | Gloves | gloves | | | |
| | Heat resistance | Proximity | | | | | apperin/ | suit/ | Door | suit | . . . |
| | | Suit | | | | | Gloves | Gloves | | | |
| 10 | RUBBER & TYRE INDS. | | | | | | | | | | |
| | Sr. No. | 1 | 2 | 3 | 4 | 5 | 6 | 7 | 8 | 9 | 10 |
| | Name the | Fire | | | | | Welding | Furnace | Fire | Paint | Hot |
| | utility area | Fighter | | | | | Area | | Door | Booth | Machines |
| | | Team | | | | | | | | | |
| | Fire resistance | Fire Suit | | | | | suit/ | suit/ | Door | suit | . . . |
| | | | | | | | Gloves | Gloves | | | |
| | Heat resistance | Proximity | | | | | apperin/ | suit/ | Door | suit | Insulation |
| | | Suit | | | | | Gloves | gloves | | | |
| 11 | PETROLIUM & GAS INDS. | | | | | | | | | | |
| | Sr. No. | 1 | 2 | 3 | 4 | 5 | 6 | 7 | 8 | 9 | 10 |
| | Name the | Fire | | | | | Welding | Furnace | Fire | Paint | Others |
| | utility area | Fighter | | | | | Area | | Door | Booth | |
| | | Team | | | | | | | | | |
| | Fire resistance | Fire Suit | | | | | suit/ | suit/ | Door | suit | . . . |
| | | | | | | | Gloves | Gloves | | | |
| | Heat resistance | Proximity | | | | | apperin/ | suit/ | Door | suit | . . . |
| | | Suit | | | | | Gloves | Gloves | | | |
| 12 | CORPORATE HOUSES | | | | | | | | | | |
| | Sr. No. | 1 | 2 | 3 | 4 | 5 | 6 | 7 | 8 | 9 | 10 |
| | Name the | Emp. & | | | | | Fire | | Fire | | |
| | utility area | Cust | | | | | Fighter | | Door | | |
| | | Resque | | | | | | | | | |
| | Fire resistance | Suit | Net, | | | | Fire Suit | | Door | | |
| | | | Ropes & | | | | | | | | |
| | | | Ladder | | | | | | | | |
| | Heat resistance | Suit | | | | | Proximity | | Door | | |
| | | | | | | | Suit | | | | |
| 13 | BANKING INDS. | | | | | | | | | | |
| | Sr. No. | 1 | 2 | 3 | 4 | 5 | 6 | 7 | 8 | 9 | 10 |
| | Name the | | | | | | Fire | Emp. | Fire | | |
| | utility area | | | | | | Fighter | Resque | Door | | |
| | Fire resistance | | | | | | Fire Suit | Suit | Door | | |
| | Heat resistance | | | | | | Proximity | Suit | Door | | |
| | | | | | | | Suit | | | | |
| 14 | KITCHEN-DOMESTIC OR COMMERCIAL | | | | | | | | | | |
| | Sr. No. | 1 | 2 | 3 | 4 | 5 | 6 | 7 | 8 | 9 | 10 |
| | Name the | Daily | | | | | Fire | Resque | | | |
| | utility area | Cooking | | | | | Extinguish | | | | |
| | | Safely | | | | | | | | | |
| | Fire resistance | | | | | | Blanket | Blanket | | | |
| | | | | | | | | or Suit | | | |
| | Heat resistance | Apperin | | | | | | | | | |
| | | to protect | | | | | | | | | |
| | | from | | | | | | | | | |
| | | boiled | | | | | | | | | |
| | | cooking | | | | | | | | | |
| | | oil | | | | | | | | | |
| 15 | WOODEN & TIMBER | | | | | | | | | | |
| | Sr. No. | 1 | 2 | 3 | 4 | 5 | 6 | 7 | 8 | 9 | 10 |
| | Name the | | | | | | Fire | Emp. | Fire | | |
| | utility area | | | | | | Fighter | Resque | Door | | |
| | Fire resistance | | | | | | Fire Suit | Suit | Door | | |
| | Heat resistance | | | | | | Proximity | Suit | Door | | |
| | | | | | | | Suit | | | | |
| 16 | HOTEL INDUSTRY | | | | | | | | | | |
| | Sr. No. | 1 | 2 | 3 | 4 | 5 | 6 | 7 | 8 | 9 | 10 |
| | Name the | Emp. & | | | | | Fire | Emp. & | Fire | | |
| | utility area | Cust | | | | | Fighter | Cost | Door | | |
| | | Resque | | | | | | Resque | | | |
| | Fire resistance | Suit | Net, | | | | Fire Suit | Suit | Door | | |
| | | | Ropes & | | | | | | | | |
| | | | Ladder | | | | | | | | |
| | Heat resistance | Suit | | | | | Proximity | Suit | Door | | |
| | | | | | | | Suit | | | | |
| 17 | CHEMICAL INDUSTRY | | | | | | | | | | |
| | Sr. No. | 1 | 2 | 3 | 4 | 5 | 6 | 7 | 8 | 9 | 10 |
| | Name the | Chemical | | | | | Welding | Emp. | Fire | Paint | Heated |
| | utility area | Treatment | | | | | Area | Resque | Door | Booth | Pipe |
| | | Area | | | | | | | | | Lines |
| | Fire resistance | | | | | | suit/ | Suit | Door | suit | . . . |
| | | | | | | | Gloves | | | | |
| | Heat resistance | Suit to | | | | | apperin/ | Suit | Door | suit | Insulation |
| | | Protect | | | | | Gloves | | | | |
| | | from | | | | | | | | | |
| | | Chemical | | | | | | | | | |
| | | Heat & | | | | | | | | | |
| | | Skin | | | | | | | | | |
| | | Reaction | | | | | | | | | |
| 18 | BUILDING CONSTRUCTION | | | | | | | | | | |
| | Sr. No. | 1 | 2 | 3 | 4 | 5 | 6 | 7 | 8 | 9 | 10 |
| | Name the | | Building | | | | Welding | Emp. | Fire | Paint | |
| | utility area | | Nature | | | | Area | Resque | Door | Booth | |
| | Fire resistance | | Fire | | | | suit | Suit | Door | suit | |
| | | | Rated | | | | | | | | |
| | | | Walls | | | | | | | | |
| | Heat resistance | | Insulation- | | | | apperin | Suit | Door | suit | |
| | | | Wall & | | | | | | | | |
| | | | Roof | | | | | | | | |

| | | |
|---|---|---|
| 19 | WIND | Thermal Insulation Solutions |
| | ENERGY | |
| 20 | NUCLEAR | Thermal Insulation Solutions |
| | ENERGY | |
| 21 | FOOD | Thermal Insulation and Fire Protective Solutions |
| | INDUSTRY | |
| 22 | MILITARY | Thermal Insulation and Fire Protective Solutions for Army |
| | | personnel and vehicals and other solutions |
| 23 | MINING | Fire Protecting apparels and solutions |
| 24 | FORESTORY | Fire protection solutions |
| 25 | WELDING | Welding blankets and other allied solutions |

1. A thermal insulation and fire protecting material, comprising:
(i) a fire retardant composition having
(a) about 15 to 40 wt % of carbon,
(h) about 0.5 to 35 wt % of silicate, and
(c) about 0.25 to 45 wt % of silica,
the percentage being based on weight of the fire retardant composition; and
(ii) a glass fiber; a reinforcing material; aluminium; a high temperature resistance solvent; graphite; or any combination thereof.

2. The thermal insulating and fire protecting material as claimed in claim 1, wherein the silicate is selected from abhrak/mica, sodium silicate or a combination thereof.

3. The thermal insulating and fire protecting material as claimed in claim 1, wherein the fiber is a glass fiber, silica fiber, or a combination thereof.

4. The thermal insulating and fire protecting material as claimed in claim 1, wherein the reinforcing material comprises starch, benzoin oil, resin, magma, magma florex or a combination thereof.

5. The thermal insulating and fire protecting material as claimed in claim 1, wherein the high temperature resistance solvent is a silicate solution or adhesive.

6. The thermal insulating and fire protecting material as claimed in claim 1, wherein the thermal insulating and fire protecting material is an insulating gel, comprising about 20-40 wt % of carbon, about 15-35 wt % abhrak/mica, about 25-45 wt % aluminum, about 25-45 wt % silica, about 20-35 wt % graphite, and a high temperature resistance solvent, the percentage being based on weight of the insulating gel.

7. The thermal insulating and fire protecting material as claimed in claim 6, wherein the insulating gel is prepared by a process comprising:
(i) mixing about 20-40 wt % of carbon, about 15-35 wt % abhrak/mica, about 25-45 wt % aluminum, about 25-45 wt % silica, and about 20-35 wt % graphite to obtain a mixture; and
(ii) adding a high temperature solvent or adhesive to the mixture to obtain the thermal insulating gel.

8. The thermal insulating and fire protecting material as claimed in claim 1, wherein the thermal insulating and fire protecting material is a yarn and prepared by a process comprising:
(i) treating glass fiber with chemical liquid of the present invention to obtain a treated fiber;
(ii) passing the treated fiber in to a heat chamber having a constant temperature in the range 100-500° C., where it passes through a diamond polished dyes of size in the range of 0.5 mm to 1 mm, kept in series at equidistance with each other, wherein the same temperature is maintained for each diamond based dye throughout the heat chamber;
(iii) providing the treated fibers to a krill, wherein the krill is kept at the last end of the heat chamber; and
(iv) shaping the treated fibers into yarn and winding the yarn to make a cone of the yarn.

9. The thermal insulating and fire protecting material as claimed in claim 8, wherein the yarn comprises glass fiber coated with a chemical liquid, wherein the chemical liquid comprises:
(i) about 15-40 wt % carbon,
(ii) about 0.5-3 wt % silicate,
(iii) about 0.25-5 wt % silica,
(iv) about 0.254 wt % starch,
(v) about 6.5 wt % resin,
(vi) benzoin oil,
(vii) about 0.1-3 wt % magma, and
(viii) magma florex in a ratio of 5 gm to 50 gm of magma florex to 200 liter of water;
the percentage being based on weight of the glass fiber to be coated.

10. The thermal insulating and fire protecting material as claimed in claim 1, wherein the material is a fabric comprising the thermal insulating and fire protecting yarn.

11. The thermal insulating and fire protecting material as claimed in claim 1 for use in preparing an article wherein the article is selected from fire resistant and/or fire retardant hard board, fire resistant and/or fire retardant doors, fire proof lockers or cabins, fire resistant wearables, fire resistant and/or fire retardant wall panels or linings, fire resistant and/or fire retardant ceiling panels or linings, fire resistant and/or fire retardant furniture, thermal resisting composite materials.

12. The thermal insulating and fire protecting material as claimed in claim 10, is a composite material comprising:
(i) a layer of an aluminized glass fiber cloth on the uppermost side;
(ii) a layer of the thermal insulating and fire protecting fabric under the layer of the aluminized glass fiber cloth;
(iii) a layer of a glass fiber under the layer of thermal insulating and fire protecting fabric;
(iv) a layer of the insulating gel spread on ceramic wool or ceramic cloth or both on its both side and covered with a cotton cloth or fire retardant cloth with the help of silicate glue under the layer of glass fiber followed by another layer of thermal insulating and fire protecting fabric; and
(v) a last layer of fire retardant cloth or blanket or ceramic woolen lining;
wherein all the layers are knitted from all four sides, as well as transactional sides with the thermal insulating and fire protecting yarn.

13. The thermal insulating and fire protecting material as claimed in claim 10, is a wearable material comprising:
(i) a layer of an aluminized glass fiber on the outermost side followed by silica covering;
(ii) optionally a layer of a non-woven carbon adjacent to the layer of the aluminized glass fiber with the silica covering;
(iii) a layer of the thermal insulating and fire protecting fabric, under the layer of aluminized glass fiber with the silica covering or the non-woven carbon;
(iv) optionally another layer of a non-woven carbon;
(v) optionally a layer of a ceramic wool or ceramic cloth or both layering in between the thermal insulating and fire protecting fabric layer and the carbon non-woven layer;
(vi) optionally a layer of neoprene Teflon adjacent to ceramic wool layer; and
(vii) a last layer of woolen thermal lining or cotton cloth;
wherein all the layers are stitched with the thermal insulating and fire protecting yarn.

14. A The thermal insulating and fire protecting material as claimed in claim 10, is a wearable material comprising:
(i) a layer of a fire retardant cloth on the outermost side followed by silica covering;
(ii) optionally a layer of non-woven carbon adjacent to the layer of the fire retardant cloth with the silica covering;
(iii) a layer of the thermal insulating and fire protecting fabric under the layer of the fire retardant cloth with the silica covering or the layer of the non-woven carbon;
(iv) optionally another layer of a non-woven carbon;
(v) optionally a layer of neoprene rubber adjacent to the layer of point (iii), and
(vi) a layer of woolen thermal lining or cotton cloth;
wherein, all the layers are stitched with the thermal insulating and fire protecting yarn.

15. A thermal insulating and fire protecting door, comprising:
(i) zinc coated stainless steel sheet for steel frame, or wooden frame for wooden tire door;
(ii) fire retardant glue;
(iii) calcium carbate;
(iv) a sheet of thermal insulating and tire protecting fabric as claimed in claim 10;
(v) rock wool or ceramic wool or a combination thereof; and
(vi) an intumescent material.

16. A thermal insulating and fire protecting Hard Board obtained by a process comprising:
(i) making a liquid paste of resin;
(ii) mixing this paste with about 50-90 wt. % of ceramic fiber to obtain a composition;
(iii) putting the composition in a dye of desired size under pressure of about 4 tons to about 20 tons for a period of about 5 hrs to 20 hrs;
(iv) providing heat keeping constant temperature of around 100° C. to 700° C., while keeping the developed material on pressure machine; and
(v) optionally applying the thermal insulating and fire protecting fabric sheet or the insulating gel.
